(19) United States
(12) Patent Application Publication
(10) Pub. No.: US 2025/0237091 A1
(43) Pub. Date: Jul. 24, 2025

(54) ROTATING ARM PROTECTIVE LOCK

(71) Applicant: Ningbo Eudemon Child Protective Equipment Co., Ltd., NINGBO (CN)

(72) Inventors: Xueming Zhang, NINGBO (CN); Zhen Zhang, NINGBO (CN)

(21) Appl. No.: 19/176,075

(22) Filed: Apr. 10, 2025

(30) Foreign Application Priority Data
Mar. 20, 2025 (CN) 202520499871.6

(51) Int. Cl. E05B 65/00; F24C 15/02

(52) U.S. Cl. CPC E05B 65/0014; F24C 15/022

(57) ABSTRACT

The present invention discloses a rotating arm protective lock and a connection locking structure thereof. The protective lock includes a first lock member, a second lock member, a connecting mechanism and a locking mechanism, the second lock member is arranged to rotate between a first state and a second state, and the connecting mechanism is actuated in an axial direction to drive the locking mechanism to engage or disengage to lock or unlock rotation of the second lock member. The protective lock of the present invention can lock an oven door in a fully closed position, and is unlocked by simultaneous operation on both sides to avoid operation by children.

### TECHNICAL FIELD

The present invention belongs to the field of child protection locks, and in particular relates to a rotating arm protective lock which can be used to lock an oven door or the like.

### BACKGROUND

With the improvement of people's living standards, furniture and household appliances are becoming more and more popular in home life, which not only brings convenience to people's lives, but also may cause potential safety hazards. For example, children may operate doors of furniture or appliances out of curiosity or imitation of adults, such as ovens with open doors, which may burn children during operation due to high temperature. Furthermore, it is also possible to pinch fingers when closing the door.

Therefore, it is necessary to develop protective locks to prevent unauthorized operations from harming children. For example, Chinese patent No. CN213898513U discloses a sliding protective lock that locks or unlocks an oven through rotation of a lock body thereof relative to a rotating base. Similarly, Chinese patent No. CN213898513U discloses a sliding protective lock that realizes locking or unlocking operation by sliding a lock body thereof relative to a base.

However, the existing protective locks are easy to unlock, and children may try or imitate adult operation multiple times to open the oven door. Moreover, it is also difficult for the protective lock to lock the oven door in a fully locked position, resulting in minimal opening space for the oven door. In addition, it is not allowed to open the oven door or the like to a predetermined small extent for heat dissipation.

### SUMMARY

It is an object of the present invention to provide a rotating arm protective lock capable of locking an oven door in a fully locked position and allowing the oven door to open for heat dissipation.

In one embodiment, a rotating arm protective lock is provided, including a first lock member and a second lock member, where the second lock member includes a rotating shaft portion and a rotating arm, and the second lock member is pivotally connected to the first lock member. Therefore, the locking of a component to be protected such as an oven door can be realized by rotation of the rotating arm about an axis. Compared with sliding locks and flat rotary locks, a locked position used to lock the component to be protected in the locked state can be adjusted as needed, and can be completely locked or opened at a small distance for ventilation and heat dissipation.

The rotating arm protective lock further includes a connecting mechanism and a locking mechanism; the locking mechanism includes a first proximity lock member and a second proximity lock member; and the first proximity lock member and the second proximity lock member are respectively arranged on the connecting mechanism and the first lock member or the second lock member, that is, the second proximity lock member is arranged on one of the first lock member or the second lock member when the first proximity lock member is arranged on the connecting mechanism, and the first proximity lock member is arranged on the first lock member or the second lock member when the second proximity lock member is arranged on the connecting mechanism.

And the connecting mechanism is connected between a pivot arm of the first lock member and the rotating shaft portion of the second lock member, so that the second lock member is arranged to rotate between a first state and a second state. The connecting mechanism is actuated in an axial direction to drive the first proximity lock member to engage with or disengage from the second proximity lock member to lock or unlock rotation of the second lock member.

By adopting such a technical solution, in addition to having a specific position for adjusting the locked state as needed, it is also possible to simplify the structure and prevent children from operating.

In one embodiment, a first connecting member and a second connecting member of the connecting mechanism are respectively telescopically movable in an axial direction, the second connecting member is non-rotatably sleeved in the first connecting member, and a first locking closure member and a second locking closure member are misaligned, so that twice the number of locking gears can be provided in the same structural size range.

In one embodiment, the first locking closure member, the second locking closure member and a third locking closure member are all toothed members, when the third locking closure member is meshed with the first locking closure member, the second locking closure member is abutted to retract in the axial direction, and when the third locking closure member is meshed with the second locking closure member, the first locking closure member is abutted to retract in the axial direction.

The present invention also provides a connection locking structure for a rotating arm protective lock, which is composed of the connecting mechanism and the locking mechanism described above.

The present invention has at least the following beneficial effects:
1. The second lock member rotates along a pivot parallel to a bottom surface thereof, so that the second lock member can not only lock the component to be locked such as an oven door in a fully locked position, but also can be adjusted in rotation angle to open the component to be locked at a predetermined angle for heat dissipation, which enrich the functions of the protective lock and diversify the applicable scenarios.
2. The protective lock is unlocked by pressing on both sides thereof, and the second lock member needs to be rotated while keeping pressed, thus reducing the possibility of opening by a child and improving safety.
3. The locking mechanism is integrated on first and second locking mechanism and the connecting mechanism, making it easy to manufacture and assemble, and reducing costs.
4. By arranging the first locking closure member and the second locking closure member, it is possible to realize that the second lock member can be locked with twice the number of rotation gears in the same size space, achieving twice the degree of adjustment on the same product and better adaptability.

### BRIEF DESCRIPTION OF THE DRAWINGS

FIG. 1 is a schematic structural diagram of a protective lock according to Embodiment 1 of the present invention in a closed state;

FIG. 2 is a schematic structural diagram of the protective lock of the embodiment of FIG. 1 transitioned to an open state, and is formed by pivoting a second lock member along a pivot from FIG. 1 according to a path indicated by a two-way arrow in the figure;

FIG. 3 is a schematic structural exploded view of the protective lock of the embodiment of FIG. 1;

FIG. 4 is a schematic structural exploded view of a first lock member in the embodiment of FIG. 1;

FIG. 5 is a schematic structural enlarged view of A in FIG. 4;

FIG. 6 is a schematic structural enlarged view of B in FIG. 4;

FIG. 7 is a schematic structural exploded view of a second lock member and a connecting mechanism in the embodiment of FIG. 1;

FIG. 8 is a schematic structural exploded view of the second lock member, the connecting mechanism and a first shaft member;

FIG. 9 is a schematic structural exploded view of a first connecting member and a second connecting member in FIG. 7; and

FIG. 10 is a schematic structural side view of the connecting mechanism mounted on the second lock member, with a part of the second lock member not shown.

### DESCRIPTION OF THE EMBODIMENTS

In order to make those skilled in the art better understand the present invention and thereby define the scope of the present invention more clearly, the present invention is described below in detail with respect to some specific embodiments of the present invention.

### Embodiment 1

A rotating arm protective lock can be mounted on an oven as an oven lock to prevent children from opening the oven door and avoid injuries such as burs and pinching of fingers.

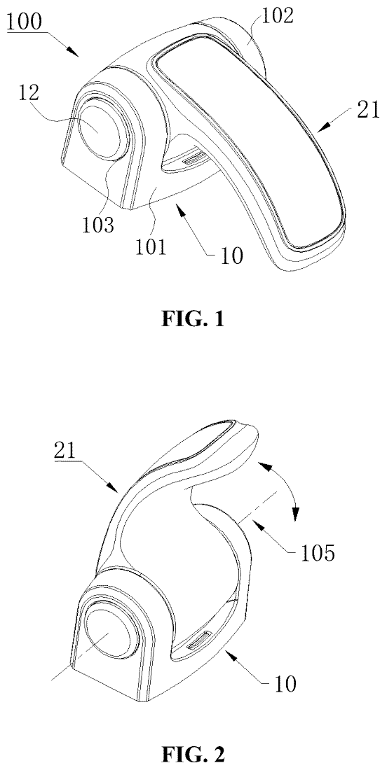

As shown in FIGS. 1 and 2, the protective lock member 100 is integrally composed of a first lock member 10 and a second lock member 21, where first lock member 10 is mounted to an oven, and the second lock member 21 is rotatably connected to the first lock member 10, so that the oven door can be locked or unlocked by pivoting the second lock member 21, forming a first state and a second state of the protective lock, the first state refers to locking of the oven door, the second state refers to unlocking of the oven door, and a rotation angle of the second lock member 21 between the first state and the second state can be set as desired, for example, 60°, 90° or other angles.

The first lock member 10 is in a U-shape as a whole (i.e., three sides are connected to each other), and includes a first body 101 and two pivot arms 102. The pivot arms 102 are arranged at both ends of the first body 101 to form the U-shape, and pivot holes 103 are correspondingly provided on the two pivot arms 102. After a shaft member 12 passes through the pivot holes 103, the second lock member 21 is pivotably mounted on the first lock member 10, so that the second lock member 21 is pivotably mounted on the first lock member 10 about a pivot axis 105, and the second lock member 21 is pivotably movable between a locked state shown in FIG. 1 (i.e., the second state) and an open state shown in FIG. 2 (i.e., the first state), with a rotation path shown by a two-way arrow in FIG. 2.

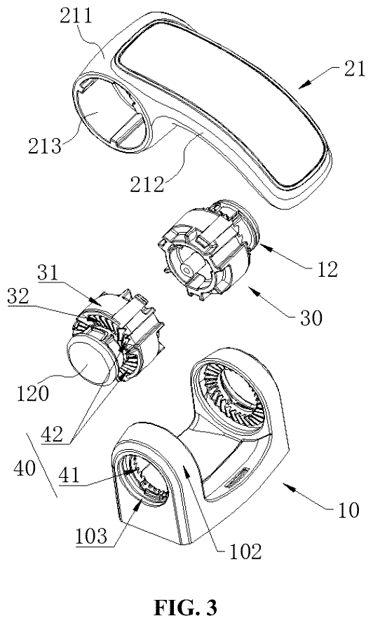

As shown in FIG. 3, the second lock member 21 is mounted on the first lock member 10 via a connecting mechanism 30. Specifically, the connecting mechanism 30 is inserted into a first cavity 213 of the second lock member 21 and an inner pivot hole 103 of the first lock member 10, so that the second lock member 21 is pivotally mounted.

In order to lock the second lock member 21 in the first state or the second state to remain in the locked state or the open state, the protective lock 100 further has a locking mechanism 40 acting between the first lock member 10 and the second lock member 21, the locking mechanism 40 is composed of a first proximity lock member 41 and a second proximity lock member 42 respectively provided on the first lock member 10 and the second lock member 21, and the pivoting of the second lock member 21 is locked or unlocked by displacement movement of engaging or disengaging the first proximity lock member 41 with or from the second proximity lock member 42 in the direction of the pivot axis 105. The first proximity lock member 41 and the second proximity lock member 42 are meshed with each other when they approach each other, such as gear meshing.

In the present embodiment, the first proximity lock member 41 is arranged on the pivot arm 102 and around an outer periphery of the pivot hole 103, the second proximity lock member 42 is arranged at a corresponding position on the connecting mechanism 30, and the connecting mechanism 30 is fixedly assembled in the first cavity 213 on the second lock member 21 and can be displaceable along the pivot axis 105 relative to the second lock member 21, so that the connecting mechanism 30 is only telescopically movable in the axial direction and is non-rotatable in a circumferential direction in the first cavity 213, where the fixed assembly means that a limiting mechanism with circumferential rotation prevents the connecting mechanism 30 from rotating.

For example, a first limiting member 214 is provided on an inner side wall of the first cavity 213, and a second limiting member 215 is correspondingly provided on an outer side wall of the connecting mechanism 30, the first limiting member 214 is a convex member, and the second limiting member 215 is a concave member, so that the first limiting member 214 and the second limiting member 215 are in concave-convex fit, so that the circumferential rotation of the connecting mechanism 30 relative to the first cavity 213 is limited and cannot be achieved. In other embodiments, a concave-convex limiting mechanism may be provided on respective bottom walls of the first cavity 213 and the connecting mechanism 30 to limit rotation of the connecting mechanism 30 through the concave-convex fit.

Accordingly, when the second proximity lock member 42 is telescopically moved in the axial direction with the connecting mechanism 30, the second proximity lock member 42 can approach or move away from the first proximity lock member 41 to lock or unlock the locking mechanism 40.

As shown in FIG. 3, a pivot cavity 104 is formed between the two pivot arms 102 for mounting the rotating shaft portion 211 of the second lock member 21 therein, and the connecting mechanism 30 further includes a shaft member 12. In the present embodiment, the shaft member 12 is composed of a first shaft member 120, after assembly, the first shaft member 120 is inserted into the pivot hole 103 of the pivot arm 102, and the first shaft member 120 and the pivot hole 103 form rotating assembly to rotatably mount the second lock member 21 and the connecting mechanism 30 on the first lock member 10. The second lock member 21 further includes a rotating arm 212 connected or integrally formed with the rotating shaft portion 211, and rotating shaft portion 211 is configured to be pivotally mounted on the first lock member 10, and the rotating arm 212 is configured to prevent or allow opening of the oven door.

Here, the first shaft member 120, on the one hand, has the rotational connection function as described above, and on the other hand, is also configured to drive displacement movement of the connecting mechanism 30 in the first cavity 213, thus manipulating the locking mechanism 40 to transition between the locked state and the unlocked state. When the connecting mechanism 30 is in a position close to the pivot arm 102, the locking mechanism 40 is in a locked state; and when the connecting mechanism 30 is pushed away from the pivot arm 102 by the first shaft member 120, the second proximity lock member 42 is disengaged from the first proximity lock member 41 to cause the locking mechanism 40 to transition to the locked state.

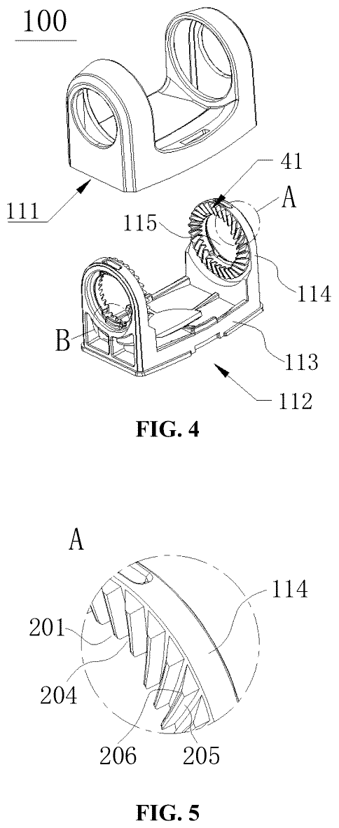

In the present embodiment, the first lock member 10 is composed of a shell member 111 and a core member 112. As shown in FIG. 4, a cavity is provided in the shell member 111 to at least partially mount the core member 112 therein, where the core member 112 is used as a main function and structural member of the first lock member 10 to realize the function of the first lock member 10 and mainly meet the structural strength, and the shell member 111 is configured to shape the appearance of the first lock member 10 and assist in meeting the structural strength, so that the structural design, appearance design and material selection of the first lock member 10 are more diversified. Of course, in other embodiments, the first lock member 10 may be integrally formed.

Here, the core member 112 includes a core bottom member 113 and two core arm members 114 provided on the same side at both ends of the core bottom member 113, the core member 112 is inserted into a cavity provided in the shell member 111 and fastened with the shell member 111, and a bottom surface of the core bottom member 113 of the core member 112 is formed as a bottom surface of the first lock member 10 for being fixed to the oven, for example, by adhesive fixing. The first proximity lock member 41 is provided on an inner wall of the core arm member 114, and a core shaft hole 115 is penetratingly provided on both core arm members 114, and the first proximity lock member 41 is arranged around an outer periphery of the core shaft hole 115.

As shown in FIG. 5, the first proximity lock member 41 includes a plurality of third locking closure members 201 arranged in an array along an circumferential direction, the third locking closure members 201 are arranged at intervals to form a tooth cavity 204 between adjacent third locking closure members 201, and both sides of the third locking closure members 201 are respectively provided with a first tooth wall 205 and a second tooth wall 206, the first tooth wall 205 is a limiting surface generally perpendicular to an inner wall surface of the core arm member 114, and the second tooth wall 206 is a guide surface inclined relative to the inner wall surface of the core arm member 114, where the first tooth wall 205 and the second tooth wall 206 can meet their respective functions and be specifically arranged as needed.

Preferably, the first locking closure member 202, the second locking closure member 203, and the third locking closure member 201 are all composed of toothed members, that is, they include at least one tooth member to engage with each other in a meshing manner.

Therefore, in the present embodiment, the first proximity lock member 41 is formed as a one-way locking mechanism, the second lock member 21 is not locked by the locking mechanism 40 when rotated from the open state to the locked state, but is locked by the locking mechanism 40 when rotated from the locked state to the open state, and can be operated only after the locking mechanism 40 is unlocked.

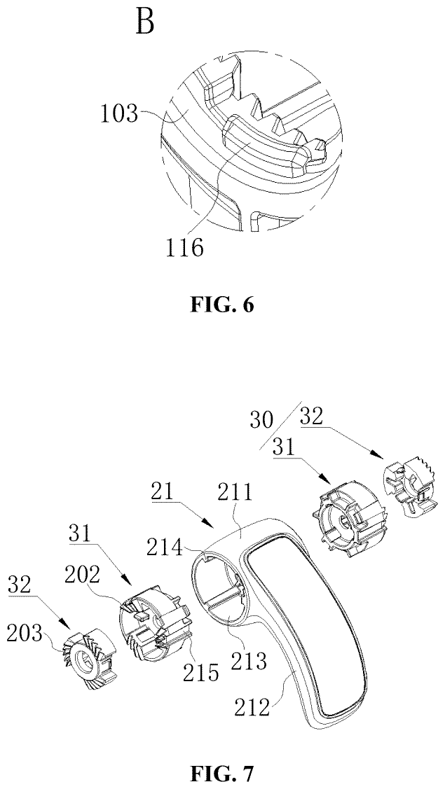

In the present embodiment, the pivot arm 102 is provided with a first clamping member 116, and a second clamping member 123 is correspondingly provided on the first shaft member 120. The first clamping member 116 and the second clamping member 123 abut against each other to prevent the first shaft member 120 from coming out of the pivot hole 103, and the first clamping member 116 is preferably arranged on the core arm member 114, as shown in FIG. 6.

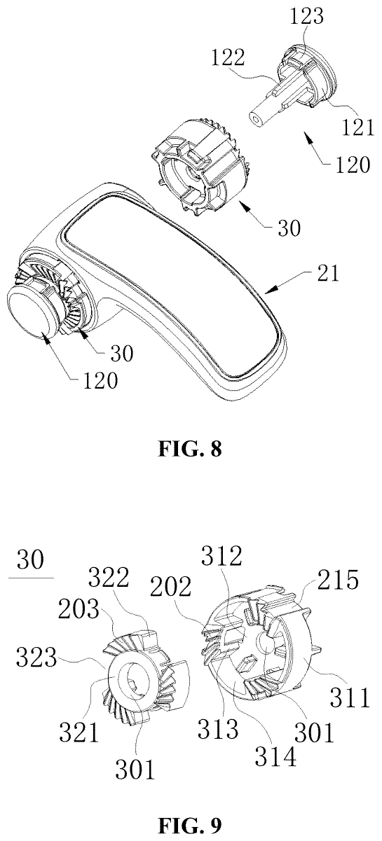

As shown in FIG. 8, the first shaft member 120 includes a first shaft portion 121 and a second shaft portion 122 extending on one side of the first shaft portion 121, where the first shaft portion 121 is configured to be inserted into the pivot hole 103, and the second shaft portion 122 is configured to be inserted into a connecting hole 301 of the connecting mechanism 30. In the present embodiment, the second shaft portion 122 is freely rotatable with respect to the connecting mechanisms 30.

As shown in FIG. 7, one connecting mechanism 30 is respectively provided on left and right sides of the second lock member 21. The rotating shaft portions 211 can be respectively arranged on both sides of the second lock member 21, and an elastic member such as a return spring may be provided between each connecting mechanism 30 and a bottom wall of the rotating shaft portion 211, so that the connecting mechanism 30 is initially in the extended position, that is, a position in which the locking mechanism 40 is in the locked state. In other embodiment, one rotating shaft portion 211 penetrating from the left to the right can be provided in the second lock member 21, and a return spring can be provided between the two connecting mechanisms 30.

As shown in FIGS. 7-9, the connecting mechanism 30 includes a first connecting member 31 and a second connecting member 32, the second connecting member 32 is sleeved in the first connecting member 31, and the first connecting member 31 and the second connecting member 32 are each independently arranged to be telescopically movable along the axial direction. The first connecting member 31 includes a second body 311 and a second cavity 312 formed in the second body 311, and the second connecting member 32 is at least partially sleeved and accommodated in the second cavity 312 and fixedly assembled (i.e., cannot rotate relatively); a first convex wall member 313 and a first positioning cavity 314 are provided at an outer periphery of the second cavity 312 of the first connecting member 31 (i.e., a radial outer side of the second cavity 312); the second connecting member 32 includes a third body 321 and a second convex wall member 322 and a second positioning cavity 323 provided at an outer periphery of the third body 321; and the first convex wall member 313 and the second positioning cavity 323, and the second convex wall member 322 and the first positioning cavity 314 are correspondingly arranged (the shape of a missing portion inside the first connecting member 31 is substantially complementary to an outer contour shape of the second connecting member 32 to allow the second connecting member 32 to be sleeved in the first connecting member 31), so that the second connecting member 32 and the first connecting member 31 rotate together, and the second convex wall member 322 and the first positioning cavity 314 form a second rotation limiting structure.

In the present embodiment, specifically, a first return spring is provided between the first connecting member 31 and the bottom wall of the rotating shaft portion 211, so that the connecting mechanism 30 is initially in the extended position, and a second return spring is provided between the second connecting member 32 and the first connecting member 31 to provide an outward tendency force so that the first connecting member 31 and the second connecting member 32 can independently form and maintain an extended state. In other embodiments, the first connecting member 31 and the second connecting member 32 may each be maintained extended by a return spring.

The second proximity lock member 42 includes a first locking closure member and a second locking closure member; the first locking closure member is arranged on an end face of the first connecting member 31, more specifically, on the first convex wall member 313; and the second locking closure member is arranged on an end face of the second connecting member 32, more specifically, on the second convex wall member 322. Moreover, locking units of the first locking closure member and the second locking closure member are arranged in a staggered manner, so that the first proximity lock member 41 is alternately engaged with the first locking closure member and the second locking closure member. Preferably, the locking unit of the first locking closure member and the locking unit of the second locking closure member are arranged to stagger by half a rotation angle in the circumferential direction, so that when the first proximity lock member 41 is engaged with the locking unit of one of the first locking closure member and the second locking closure member, the locking unit of the other abuts against a locking unit of the first proximity lock member 41 to retract. For example, when the third locking closure member 201 is meshed with the first locking closure member 202, the second locking closure member 203 correspondingly abuts against the third locking closure member 201 to cause the second connecting member 32 to slightly retract, and similarly, when the third locking closure member 201 is meshed with the second locking closure member 203, the first locking closure member 202 correspondingly abuts against the third locking closure member 201 to cause the first connecting member 31 to slightly retract.

Here, the connecting hole 301 is arranged on the third body 321 and the second body 311 and sized to be penetrated by the second shaft portion 122. A groove extending in the axial direction is provided on an outer side wall of the first connecting member 31 as the second limiting member 215, so that the first connecting member 31 is non-rotatably mounted in the first cavity 213. Therefore, the first limiting member 214 and the second limiting member 215 form a first rotation limiting structure.

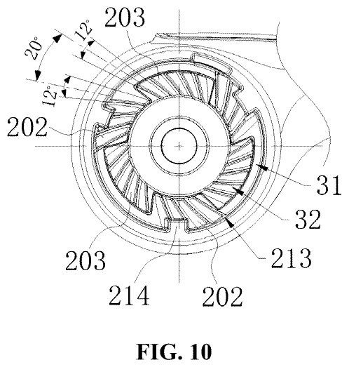

As shown in FIG. 10, the first connecting member 31 and the second connecting member 32 are provided with the first locking closure member 202 and the second locking closure member 203 respectively on the basis that the first connecting member 31 and the second connecting member 32 are non-rotatably sleeved, the first locking closure member 202 and the second locking closure member 203 can be structurally meshed with the third locking closure member 201, and the first locking closure member 202 and the second locking closure member 203 are arranged in a staggered manner so that the third locking closure member 201 is meshed with one of the them. In other words, a rotation limiting angle/limiting gear number of the third locking closure member 201 is doubled by angular misalignment of the first locking closure member 202 and the second locking closure member 203.

For example, in one embodiment, the first proximity lock member 41 has 20 third locking closure members 201, that is, an angle difference between adjacent third locking closure members 201 is 18°. If only the first locking closure member 202 is meshed with the third locking closure member, the locking position of the second locking closure member 21 is adjusted every 18°, and after the structure of the present embodiment is used, respective angle difference of the first locking closure members 202 and the second locking closure members 203 is still 18°, but there is an angular misalignment of 9° between the first locking closure member 202 and the second locking closure member 203 as a whole, so that the third locking closure member 201 can be locked every 9°, that is, meshed with the first locking closure member 202 and the second locking closure member 203 respectively. Of course, the specific locking angle value can be set as desired, but structurally the present embodiment as a whole has a double locking gear.

Accordingly, the first connecting member 31 and the second connecting member 32 are each telescopically movable in the axial direction, thus allowing each of them to telescopically move to be meshed with or disengaged from the third locking closure members 201 of the first proximity lock member 41. Here, the third locking closure member 201, the first locking closure member 202, and the second locking closure member 203 are respectively formed as a locking unit, that is, each tooth is used as a locking unit. In other embodiments, other forms of structures capable of realizing locking are also possible, such as a combination of bumps and grooves. Compared with other locking structures, the meshing locking between two complementary tooth members or the meshing locking between a tooth block and a tooth space is smoother, noiseless and can support one-way locking.

As shown in FIGS. 4 and 9-10, in the present embodiment, there are three first convex wall members 313 and three second convex wall members 322 which are uniformly distributed in the circumferential direction and misaligned with each other, and the third locking closure member 201 is a ring of tooth members around 360°. Preferably, the first locking closure member 202 and the second locking closure member 203 respectively include a plurality of tooth members and are arranged on a top surface of the corresponding convex wall member, the tooth members are arranged in a spiral pattern with a larger outer portion and a smaller inner portion, a lateral angle of each tooth member is 12°, and the tooth members of the first locking closure member 202 and the second locking closure member 203 are arranged at an angle of 20°, so that the tooth members thereof can be misaligned and alternately meshed with the third locking closure member 201, and shape design of the tooth members is beneficial to improving the meshing stability and enhancing the meshing strength. The angle shown in FIG. 10 is exemplary, and in other embodiments, the tooth member of each locking closure member can also be set in other specific ways to meet misalignment.

The use process of the protective lock 100 of the present embodiment is as follows:

First, the protective lock 100 is fixed at an appropriate position on the oven to lock or unlock the oven door. Preferably, the bottom surface of the first lock member 10 is fixed by an adhesive method.

Secondly, the second lock member 21 is rotated to a corresponding position in the locked state, and the second proximity lock member 42 is engaged with the first proximity lock member 41 to bring the locking mechanism 40 into the locked state, thus locking the second lock member 21 in the locked state.

Again, when it is necessary to release the locking of the oven door by the protective lock 100, the first shaft member 120 is operated to be pressed inward, and the first connecting member 31 and the second connecting member 32 are driven to be displaced inward so that the second proximity lock member 42 is disengaged from the first proximity lock member 41, and the rotating arm of the second lock member 21 is restored to a freely rotatable state, and the second lock member 21 is rotated to the open state to allow the oven door to be opened.

Here, with the pivoting of the second lock member 21, the third locking closure member 201 is meshed with the first locking closure member 202 and the second locking closure member 203 respectively, thus providing a double gear adjustment function.

Moreover, although in the present embodiment, the first proximity lock member 41 and the second proximity lock member 42 are continuously arranged, so the second lock member 21 is continuously locked during rotation from the locked state to the open state, as an alternative embodiment, the second lock member 21 may be locked only in these two states and not locked by the locking mechanism 40 during rotation.

Alternatively, in other embodiments, the locking mechanism 40 may be changed from the one-way locking structure of the present embodiment to a two-way locking structure, that is, the guide surface may be changed to the limiting surface.

In some other embodiments, the first proximity lock member 41 may be changed from being arranged on the first lock member 10 to being arranged on the second lock member 21. Specifically, the first proximity lock member 41 may be arranged at a side end of the first cavity 213 of the rotating shaft portion 211, such as at one side end or at both side ends at the same time. At the same time, the connecting mechanism 30 is also changed from being non-rotatably arranged in the first cavity 213 in Embodiment 1 to being rotatably arranged in the first cavity 213, and the connecting mechanism 30 is also formed to be non-rotatably connected relative to the first lock member 10.

What is claimed is:

1. A rotating arm protective lock, comprising a first lock member and a second lock member, the second lock member comprising a rotating shaft portion and a rotating arm, the second lock member being pivotally connected to the first lock member; wherein
the rotating arm protective lock further comprises a connecting mechanism and a locking mechanism, the locking mechanism comprises a first proximity lock member and a second proximity lock member, and the first proximity lock member and the second proximity lock member are respectively arranged on the connecting mechanism and the first lock member or the second lock member;
the connecting mechanism is connected between a pivot arm of the first lock member and a first cavity of the rotating shaft portion, so that the second lock member transitions between a first state and a second state; and
the connecting mechanism is actuated in an axial direction to drive the first proximity lock member to engage with or disengage from the second proximity lock member to lock or unlock rotation of the second lock member.

2. The rotating arm protective lock according to claim 1, wherein the connecting mechanism comprises a first connecting member and a second connecting member, the first connecting member and the second connecting member are respectively telescopically movable in the axial direction, and the second connecting member is non-rotatably sleeved in the first connecting member; and
the second proximity lock comprises a first locking closure member and a second locking closure member respectively provided on the first connecting member and the second connecting member, and the first locking closure member and the second locking closure member are misaligned so that the first proximity lock member is alternately engaged with the first locking closure member and the second locking closure member when the first proximity lock member is rotated.

3. The rotating arm protective lock according to claim 2, wherein the first proximity lock is composed of a third locking closure member, the first locking closure member, the second locking closure member and the third locking closure member are toothed members, and the third locking closure member is meshed with one of the first locking closure member and the second locking closure members, and abuts against the other of the first locking closure member and the second locking closure member to retract it in the axial direction.

4. The rotating arm protective lock according to claim 3, wherein the first connecting member is non-rotatably arranged in the rotating shaft portion, and the first proximity lock member is fixedly connected to the pivot arm; and
a shaft member is arranged through the pivot arm and the connecting mechanism, and the shaft member is displaceable in the axial direction to drive the connecting mechanism to be displaced in the axial direction.

5. The rotating arm protective lock according to claim 3, wherein the first proximity lock member is arranged on at least one side of the rotating shaft portion.

6. The rotating arm protective lock according to claim 3, wherein the second connecting member and the first connecting member are respectively provided with a convex member and a concave member, so that the first connecting member and the second connecting member are non-rotatably socketed; and the toothed member comprises a pair of tooth members meshed with each other, or a combination of a tooth member and a tooth space.

7. The rotating arm protective lock according to claim 6, wherein at least one of the first proximity lock member and the second proximity lock member comprises unidirectional teeth, so that opening rotation of the second lock member is locked and locking rotation thereof is allowed.

8. The rotating arm protective lock according to claim 7, wherein the first locking closure member, the second locking closure member and the third locking closure member are respectively 2-4 in number and are each evenly distributed in a circumferential direction.

9. The rotating arm protective lock according to claim 3, further comprising a first elastic member and a second elastic member, wherein the first elastic member acts on the first connecting member to provide an outward tendency, and the second elastic member acts on the second connecting member to provide an outward tendency.

10. The rotating arm protective lock according to claim 3, wherein the locking mechanism is locked continuously in a gear position or only in the first state and the second state within a rotation interval of the second lock member.

11. The rotating arm protective lock according to claim 3, wherein the first connecting member comprises a second body and a second cavity formed within the second body, a periphery of the second cavity is provided with a first convex wall member and a first positioning cavity; the second connecting member comprises a third body and a second convex wall member provided at a periphery of the third body, and a second positioning cavity is formed between the two second convex wall members; and the third body is sleeved in the second cavity, and the second convex wall member is sleeved in the first positioning cavity.

12. The rotating arm protective lock according to claim 11, wherein the first locking closure member is arranged on a top surface of the first convex wall member, and the second locking closure member is arranged on a top surface of the second convex wall member.

13. The rotating arm protective lock according to claim 4, wherein two connecting mechanisms are symmetrically arranged at both sides of the rotating shaft portion, a first limiting member is provided on a side wall or a bottom wall of the rotating shaft portion, and a second limiting member is correspondingly arranged on an outer side wall or a bottom end of the first connecting member.

14. The rotating arm protective lock according to claim 4, wherein the first lock member comprises a shell member and a core member provided within the shell member, and the first proximity lock member is arranged on the core member.

15. A connection locking structure for a rotating arm protective lock, comprising:
a connecting mechanism, the connecting mechanism being connected between a first lock member and a second lock member of the rotating arm protective lock, so that the second lock member transitions between a first state and a second state; and
a locking mechanism, the locking mechanism comprising a first proximity lock member and a second proximity lock member, and the first proximity lock member or the second proximity lock member being arranged on the connecting mechanism; and
wherein the connecting mechanism is actuated in an axial direction to drive the first proximity lock member to engage with or disengage from the second proximity lock member to lock or unlock rotation of the second lock member.

16. The connection locking structure for the rotating arm protective lock according to claim 15, wherein the connecting mechanism comprises a first connecting member and a second connecting member, the first connecting member and the second connecting member are respectively telescopically movable in the axial direction, and the second connecting member is non-rotatably sleeved in the first connecting member.

17. The connection locking structure for the rotating arm protective lock according to claim 16, wherein the second proximity lock member comprises a first locking closure member and a second locking closure member, and the first locking closure member and the second locking closure member are misaligned, so that the first proximity lock member is alternately engaged with the first locking closure member and the second locking closure member when the first proximity lock member is rotated; and
the first proximity lock is composed of a third locking closure member, the first locking closure member, the second locking closure member and the third locking closure member are toothed members, and the third locking closure member is meshed with one of the first locking closure member and the second locking closure members, and abuts against the other of the first locking closure member and the second locking closure member to retract it in the axial direction.

18. The connection locking structure for the rotating arm protective lock according to claim 17, further comprising a first elastic member and a second elastic member, wherein the first elastic member acts on the first connecting member to provide an outward tendency, and the second elastic member acts on the second connecting member to provide an outward tendency.

19. The connection locking structure for the rotating arm protective lock according to claim 18, wherein the toothed member comprises a pair of tooth members meshed with each other or a tooth member and a tooth space; and the first locking closure member and the second locking closure member are respectively arranged on a top surface of the first connecting member and a top surface of the second connecting member.

20. The connection locking structure for the rotating arm protective lock according to claim 19, wherein at least one of the first proximity lock member and the second proximity lock member comprises unidirectional teeth, so that opening rotation of the second lock member is locked and locking rotation thereof is allowed; and
wherein the first locking closure member, the second locking closure member and the third locking closure member are respectively 2-4 in number and are each evenly distributed in a circumferential direction.
